(19) United States
(12) Patent Application Publication
(10) Pub. No.: US 2026/0312638 A1
(43) Pub. Date: Oct. 8, 2026

(54) DIGITAL BEAM FORMING RECEIVE PATH

(71) Applicant: SatixFy UK Limited, Farnborough (GB)

(72) Inventor: Doron RAINISH, Farnborough (GB)

(73) Assignee: SatixFy UK Limited, Farnborough (GB)

(21) Appl. No.: 19/099,000

(22) Filed: Apr. 3, 2025

(51) Int. Cl. H04B 7/0456

(52) U.S. Cl. CPC H04B 7/0456

(57) ABSTRACT

A digital beamforming circuit that includes a plurality of channels, each having an input port configured receive an analog signal from an antenna element and a digital output signal, wherein the plurality of channels forms an electronically steerable antenna (ESA). Each channel includes: an analog-to-digital converter (ADC) connected at an output of the antenna element; a delay line circuitry configured to apply a time delay to the channel, wherein the delay line circuitry of each channel is separately controlled to apply a respective time delay, collectively enabling to steer a beam of the phased array antennas (PAA); and a phase shift circuitry configured to apply a phase shift to the channel, wherein the phase shift circuitry of each channel is separately controlled to apply a respective phase shift, collectively enabling to steer a beam of the PAA.

### FIELD OF THE INVENTION

The present invention relates generally to the field of beamforming, and more specifically digital beamforming in electronically steerable antennas (ESAs).

### BACKGROUND OF THE INVENTION

Electronically steerable antennas (ESAs) offer many advantages including electronic beam steering and reduced power consumption and weight. True-time-delay (TTD) steering techniques are typically required for controlling operation of multiple antenna elements in the array, while keeping the broad bandwidth of the antenna radiation and allowing large scan angles, so that efficient elemental vector summation (in the receive mode) or distribution (in the transmit mode) can be obtained such that it is independent of frequency or angle.

Typical implementation of an electronically steerable antenna is based on analog radio frequency (RF) phase shifting (a special case known as Phased Array Antenna (PAA)). Analog implementation suffers from several drawbacks: Due to implementation difficulties TTD is almost never implemented; Phase shifts are typically non-accurate due to production variations; and large antennas are difficult to implement due to the need for accurate and low-cost routing.

Digital implementation of ESAs (either phased array or TTD) doesn't have the above drawbacks but typically consumes more power and may cost more than the analog implementation. The main reason is that in digital implementation, each antenna element signal is up converted to RF (in the transmit path) and down converted from RF (in the receive path) so that the signal processing (such as time delay, phase shift, beam combining etc.) can be digitally implemented in baseband or low IF.

There is a need in the art for a novel beam forming technique, which will have all the advantages of digital beam forming while its cost and power consumption are less than those of analog beam forming.

### SUMMARY OF THE INVENTION

In order to address the aforementioned technical challenge, some embodiments of the present invention provide a novel architecture for the receive path of a digital beamformer, which reduces both the cost and power of prior art digital implementation. According to the invention, the RF signal is sampled by a typically low-resolution analog to digital converter (ADC) and the rest of the signal processing is done digitally.

According to some embodiments of the present invention, a digital beamforming circuit is provided herein. The digital beamforming circuit may include a plurality of channels, each having an input port configured to receive an analog signal from an antenna element and output port configured to transmit a digital signal, wherein the plurality of channels forms an electronically steerable antenna (ESA). Each channel may include an at least two-levels analog-to-digital converter (ADC) connected at an output of the antenna element; a digital delay line circuitry configured to apply a true time delay (TTD) to the channel, wherein the delay line circuitry of each channel is separately controlled to apply a respective time delay; and at least one digital RF phase shift circuitry configured to selectively apply a phase shift; wherein the at least one digital RF phase shift circuitry of each channel is separately controlled to apply a respective phase shift, collectively enabling to steer a beam of the ESA.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the invention with a digital RF phase shift circuitry in accordance with some embodiments of the present invention;

FIG. 2 illustrates the invention with a digital RF TTD circuitry in accordance with some embodiments of the present invention;

FIG. 3 illustrates the invention with a digital RF TTD circuitry and a digital RF phase shift circuitry in accordance with some embodiments of the present invention;

FIG. 4 illustrates the invention with an integer samples digital delay circuitry and a digital RF phase shift circuitry in accordance with some embodiments of the present invention;

FIG. 5 illustrates the invention with shared delays between groups of antenna elements in accordance with some embodiments of the present invention; and

FIG. 6 illustrates the invention with a multi-beam digital beamforming circuit with shared antenna elements in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

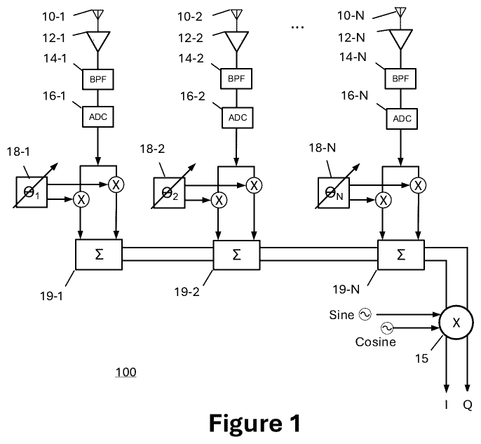

FIG. 1 is a circuit diagram showing circuit 100 which serves as a digital beamforming circuit in accordance with some embodiments of the present invention. In order to steer the antenna, a different phase shift should be applied to each antenna element as explained in detail below. Circuit 100 includes antenna elements 10-1 to 10-N whose analog outputs are feeding low-noise amplifiers LNAs 12-1 to 12-N. Analog outputs from LNAs are feeding respective band pass filters BPFs 14-1 to 14-N which serve as a shaping filter to prevent sampling replicas from reaching analog-digital converters ADCs 16-1 to 16-N. Digital outputs from ADCs are feeding phase shift circuitries 18-1 to 18-N which are controlled independently in order to apply a different phase shift to each of the signals in the different channels controlling the respective antenna elements. Phase shift circuitries output digital signals and conjugate signals which are combined in mixers 19-1 to 19-N. Both signals are feeding a multiplier 15 to generate a digital output (I,Q).

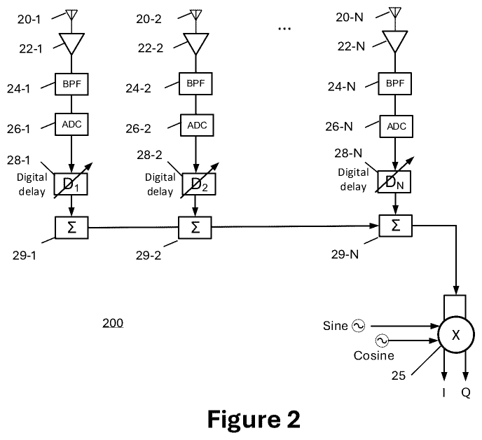

FIG. 2 is a circuit diagram showing circuit 200 which serves as a digital beamforming circuit in accordance with some embodiments of the present invention. In order to steer the antenna, different delays should be applied to each antenna element as explained in detail below. Circuit 200 includes antenna elements 20-1 to 20-N whose analog outputs are feeding low-noise amplifiers LNAs 22-1 to 22-N. Analog outputs from LNAs are feeding respective band pass filters BPFs 24-1 to 24-N which serve as a shaping filter to prevent sampling replicas from reaching analog-digital converters ADCs 26-1 to 26-N. Digital outputs from ADCs are fed into digital delay line circuitries 28-1 to 28-N which are controlled independently in order to apply a different delay to each of the signals in the different channels controlling the respective antenna elements. Output signals from all delay lines 28-1 to 28-N are combined in mixers 29-1 to 29-N and the combined signal is fed into multiplier 25 to generate a digital output (I,Q).

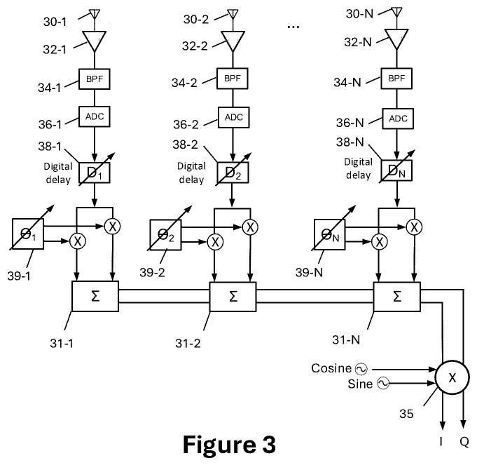

FIG. 3 is a circuit diagram showing circuit 300 which serves as a digital beamforming circuit in accordance with some embodiments of the present invention. In order to steer the antenna, different delays should be applied to each antenna element as explained above. But when the received RF signal is not in the first Nyquist zone of the ADC sampling rate, a phase correction is needed for the TTD architecture, as shown in FIG. 3. The phase correction for sub sampling is given by

$${θ}_{i} = 2 π ( {F}_{carrier} - {F}_{alias} ) {D}_{i} \qquad ( 1 )$$

where F_{carrier} is carrier frequency, Fₐₗᵢₐₛ is the alias frequency, Dᵢ is the digital delay of the channel, and θᵢ is the phase correction to be applied by the digital RF phase shift circuitry of the channel.

Circuit 300 includes antenna elements 30-1 to 30-N whose analog outputs are feeding low-noise amplifiers LNAs 32-1 to 32-N. Analog outputs from LNAs are feeding respective band pass filters BPFs 34-1 to 34-N which serve as a shaping filter to prevent sampling replicas from reaching analog-digital converters ADCs 36-1 to 36-N. Digital outputs from ADCs are fed into digital delay line circuitries 38-1 to 38-N which are controlled independently in order to apply a different delay to each of the signals in the different channels controlling the respective antenna elements. Output signals from delay lines 38-1 to 38-N are feeding digital RF phase shift circuitries 39-1 to 39-N which are controlled independently in order to apply a phase shift correction according to equation (1) to each of the signals in the different channels controlling the respective antenna element. Phase shift circuitries output digital signals and conjugate signals which are combined in mixers 39-1 to 39-N and the combined signals are fed into multiplier 35 to generate a digital output (I,Q).

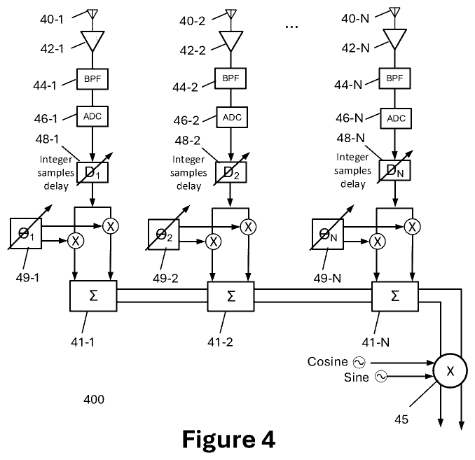

FIG. 4 is a circuit diagram showing circuit 400 which serves as a digital beamforming circuit in accordance with some embodiments of the present invention. In order to steer the antenna, different delays should be applied to each antenna element as explained above. When the received RF signal is in the Nyquist zone of the ADC sampling rate, TTD may be implemented by an integer samples digital delay and a fractional samples digital delay. The integer samples digital delay may be implemented by an integer samples digital delay circuitry. The fractional part of the TTD may be implemented by a phase shift that represents the fractional delay at the RF frequency, as illustrated in FIG. 4. For the first Nyquist zone, the phase is given by

$${θ}_{i} = 2 π * {F}_{carrier} * fractional {delay}_{i} \qquad ( 2 )$$

where fractional delayᵢ is the fractional delay of the RF signal of the channel, F_{carrier} is the carrier frequency, and θᵢ is the phase correction to be applied by the digital RF phase shift circuitry of the channel. For higher Nyquist zones:

$${θ}_{i} = 2 π * {F}_{carrier} * fractional {delay}_{i} + 2 π ( {F}_{carrier} - {F}_{alias} ) * integer {delay}_{i} \qquad ( 3 )$$

where integer delayᵢ is the integer samples delay applied to the digital integer samples delay circuitry of the channel.

Circuit 400 includes antenna elements 40-1 to 40-N whose analog outputs are feeding low-noise amplifiers LNAs 42-1 to 42-N. Analog outputs from LNAs are feeding respective band pass filters BPFs 44-1 to 44-N which serve as a shaping filter to prevent sampling replicas from reaching analog-digital converters ADCs 46-1 to 46-N. Digital outputs from ADCs are fed into digital integer sample delay lines 48-1 to 48-N which are controlled independently in order to apply a different integer samples delay to each of the signals in the different channels controlling the respective antenna element. Output signals from integer delay lines 48-1 to 48-N are feeding phase shift circuitries 49-1 to 49-N which are controlled independently in order to apply a different phase shift correction according to equation 2 for RF signals in the first Nyquist zone and according to equation 3 for RF signals in higher Nyquist zones. Phase shift circuitries output digital signals and conjugate signals which are combined in mixers 41-1 to 41-N and the combined signals are fed into multiplier 45 to generate a digital output (I,Q).

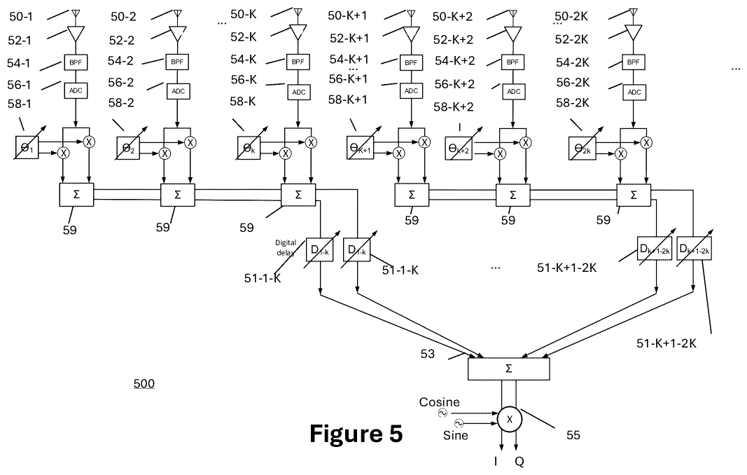

FIG. 5 is a circuit diagram showing circuit 500 which serves as a digital beamforming circuit with shared delays between groups of antenna elements in accordance with some embodiments of the present invention. Circuit 500 may include a plurality of groups of antenna elements, two are shown in FIG. 5: 50-1 to 50-K and 50-K+1 to 50-2K (K elements in each group). Outputs of the antenna elements are feeding low-noise amplifiers LNAs 52-1 to 52-K and 52-K+1 to 52-2K, respectively. Analog outputs from LNAs are feeding respective band pass filters BPFs 54-1 to 54-K and 54-K+1 to 54-2K, respectively, which serve as a shaping filter to prevent sampling replicas from reaching analog-digital converters ADCs 56-1 to 56-K and 56-K+1 to 56-2K, respectively. Digital outputs from ADCs are fed into phase shift circuitries 58-1 to 58-K and 58-K+1 to 58-2K, respectively, which are controlled independently in order to apply a different phase shift to each of the signals in the different channels controlling the respective antenna element. Phase shift circuitries output digital signals and conjugate signals which are combined in mixers 59. The mixed signal and the mixed conjugate signal from the first group of antenna elements 50-1 to 50-K are fed into delay lines 51-1-K. Similarly, the mixed signal and mixed conjugate signal from the second group of antenna elements 50-K+1 to 50-2K are fed into delay lines 51-K+1-2K. The delays of delay line pairs 51-1-K and 51-K+1-2K are controlled independently in order to apply a different delay to each of the groups of antenna elements. The outputs of all delay lines are combined in mixers 53 which feed a multiplier 55 which in turn generates a digital output (I,Q).

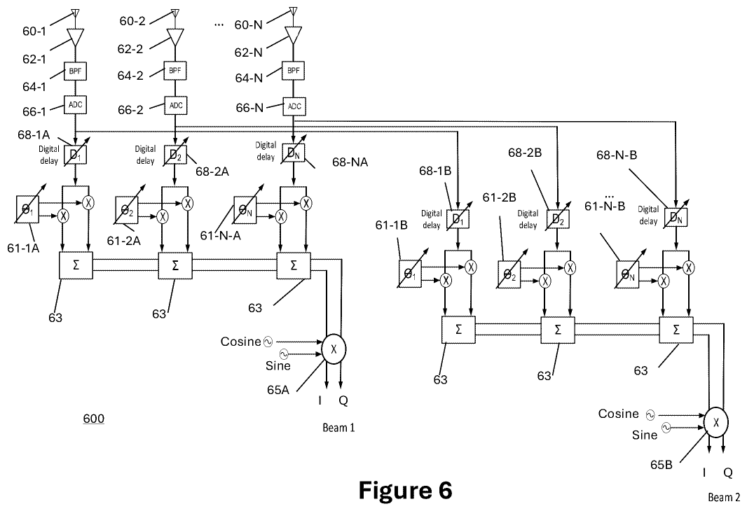

FIG. 6 is a circuit diagram showing circuit 600 which serves as a multi-beam digital beamforming circuit with shared antenna elements in accordance with some embodiments of the present invention (two beams are shown). Circuit 600 may include a plurality of formed beams sharing a plurality of antenna elements, 60-1 to 60-N. Outputs of the antenna elements are feeding low-noise amplifiers LNAs 62-1 to 62-N. Analog outputs from LNAs are feeding respective band pass filters BPFs 64-1 to 64-N, which serve as a shaping filter to prevent sampling replicas from reaching analog-digital converters ADCs 66-1 to 66-N. Digital outputs from ADCs are divided into equal-size groups and fed into delay lines 68-1A to 68-1N and 68-1B to 68-N-B (only two groups are shown, each group implements a separate beam). Each Delay line within each beam is controlled independently applying a different delay to each of the signals in the different channels controlling the respective antenna element. The delay set on the ith channel of each beam is identical (e.g., D1 set on delay line 61-1A is the same as D1 on delay line 61-1B). Outputs of delay lines are fed into phase shift circuitries 61-1A to 61-N-A and 61-1B to 61-N-B, respectively, which are controlled independently, applying a different phase shift to each of the signals in the different channels controlling the respective antenna element. The phase shift set on the ith channel of each beam is identical (e.g., θ₁ set on phase shift circuitry 61-1A is the same as θ₁ on phase shift circuitry 61-1B and is computed in accordance with Equation 1 when the received RF signal is not in the first Nyquist zone of the ADC sampling rate. Phase shift circuitries output digital signals and conjugate signals which are combined in mixers 63. The mixed signal and the mixed conjugate signal from the first beam are fed into multiplier 65A which outputs a digital signal (I,Q). The mixed signal and mixed conjugate signal from the second beam are fed into multiplier 65B which outputs a digital signal (I,Q).

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

As will be appreciated by one skilled in the art, aspects of the present invention may be embodied as a system, method, or computer program product. Accordingly, aspects of the present invention may take the form of an entirely hardware embodiment (such as combination of any of: an integrated circuit (IC), discrete RF components and an RFIC), an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skills in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A digital radio frequency (RF) delay and phase shifting beamforming circuit comprising:
a plurality of channels, each channel having an analog input port configured to receive an analog signal from an antenna element and a digital output port, wherein the plurality of channels forms an electronically steerable antenna (ESA), wherein each one of the plurality of channels comprises:
at least one analog-to-digital converter (ADC); and
at least one digital RF delay and phase shift circuitry configured to selectively apply a delay and a phase shift, wherein the at least one digital RF delay and phase shift circuitry of each channel is separately controlled to apply a respective delay and phase shift, collectively enabling to steer a beam of the ESA.

2. The digital RF delay and phase shifting beamforming circuit according to claim 1, wherein the outputs of the phase shift circuitries are divided into equal size groups, the outputs of each group are combined by a mixer and connected to a digital RF True-time-delay (TTD) delay line circuitry, wherein the at least one digital RF TTD delay line circuitry of each group is separately controlled to apply a respective true time delay, collectively enabling to steer a beam of the ESA.

3. The digital RF delay and phase shifting beamforming circuit according to claim 1, further comprising at least one integer samples digital delay and two digital variable gain multipliers configured to selectively apply a delay and phase shift, wherein the at least one digital RF delay and phase shift circuitry of each channel is separately controlled to apply a respective delay and phase shift, collectively enabling to steer a beam of the ESA.

4. The digital RF delay and phase shifting beamforming circuit according to claim 1, wherein each of the plurality of channels further comprises a band pass filter (BPF) at the input of the ADC and a line noise amplifier (LNA) at the input of the BPF, wherein the BPF serves as a shaping filter which prevents sampling replicas from reaching the ADC.

5. A digital radio frequency (RF) True-time-delay (TTD) beamforming circuit comprising:
a plurality of channels, each channel having an analog input port configured to receive an analog signal from an antenna element and a digital output port, wherein the plurality of channels forms an electronically steerable antenna (ESA), wherein each one of the plurality of channels comprises:
at least one analog-to-digital converter (ADC); and
at least one digital RF TTD line circuitry configured to selectively apply a true time delay to the signal along the channel; wherein the at least one digital RF TTD delay line circuitry of each channel is separately controlled to apply a respective true time delay, collectively enabling to steer a beam of the ESA.

6. The digital RF TTD beamforming circuit according to claim 5, wherein each one of the plurality of channels further comprises for sub-Nyquist frequencies at least one digital RF phase shift circuitry configured to selectively apply a phase shift correction to the true time delay.

7. The digital RF TTD beamforming circuit according to claim 6, wherein the plurality of channels steers a plurality of beams, sharing antenna elements and ADCs.

8. A digital radio frequency (RF) integer and fraction samples delay beamforming circuit comprising:
a plurality of channels, each channel having an analog input port configured to receive an analog signal from an antenna element and a digital output port, wherein the plurality of channels forms an electronically steerable antenna (ESA), wherein each one of the plurality of channels comprises:
at least one analog-to-digital converter (ADC); and
at least one integer samples digital delay circuitry configured to selectively apply an integer samples digital delay to the signal along the channel; and
at least one digital RF phase shift circuitry configured to selectively apply a fractional delay phase shift correction for the integer samples digital delay,
wherein the at least one integer samples digital delay circuitry is separately controlled to apply a respective delay, collectively enabling to steer a beam of the ESA.

9. A method for digital RF phase shifting beamforming comprising:
providing a plurality of channels, each having an analog input port configured to receive an analog input signal from an antenna element and a digital output port, wherein the plurality of channels forms an electronically steerable antenna (ESA);
converting, using an analog to digital converter (ADC) at each one of the plurality of channels, an output of said antenna element, into a digital signal; and
applying at least one digital RF phase shift circuitry configured to selectively apply a phase shift, wherein the at least one digital RF phase shift circuitry of each channel is separately controlled to apply a respective phase shift, collectively enabling to steer a beam of the ESA.

10. A method for digital RF TTD beamforming comprising:
providing a plurality of channels, each having an analog input port configured to receive an analog input signal from an antenna element and a digital output port, wherein the plurality of channels forms an electronically steerable antenna (ESA);
converting, using an analog to digital converter (ADC) at each one of the plurality of channels, an output of said antenna element, into a digital signal; and
applying a true time delay to the digital signal along each one of the plurality of channels, wherein the true time delay at each channel is separately controlled, collectively enabling to steer a beam of the ESA.

11. The method according to claim 10, further comprising for sub Nyquist frequencies
applying at least one digital RF phase shift circuitry configured to selectively apply a phase shift correction for the true time delay.

12. A method for digital integer and fractional samples delay beamforming comprising:
providing a plurality of channels, each having an analog input port configured to receive an analog input signal from an antenna element and a digital output port, wherein the plurality of channels forms an electronically steerable antenna (ESA);
converting, using an analog to digital converter (ADC) at each one of the plurality of channels, an output of said antenna element, into a digital signal;
applying an integer samples digital delay to the digital signal along each one of the plurality of channels, wherein the integer samples digital delay at each channel is separately controlled, collectively enabling to steer a beam of the ESA; and
applying at least one digital RF phase shift circuitry configured to selectively apply a fractional delay phase shift correction for the integer samples digital delay.
